(19) United States
(12) Patent Application Publication
(10) Pub. No.: US 2025/0232391 A1
(43) Pub. Date: Jul. 17, 2025

(54) MATCHING SYSTEM FOR CATERING

(71) Applicant: HEALTHYFOOD S.R.L., Arzignano (VI) (IT)

(72) Inventor: Pietro RUFFONI, Arzignano (VI) (IT)

(21) Appl. No.: 18/683,930

(22) PCT Filed: Sep. 5, 2022
(86) PCT No.: PCT/IB2022/058334

§ 371 Date: Feb. 15, 2024

(30) Foreign Application Priority Data
Sep. 15, 2021 (IT) 102021000023735

(51) Int. Cl. G06Q 50/12; G06Q 10/02; G06Q 20/20

(52) U.S. Cl. CPC G06Q 50/12; G06Q 10/02; G06Q 20/204

(57) ABSTRACT

A matching system for catering, adapted to match the food needs of users with the culinary offers of caterers, includes: at least a web portal and/or application adapted to provide a platform in which to allow the catering facility to easily offer a complete overview of its services; the web portal and/or application including: at least a user section, at least a catering owner section, at least a group section, at least an identification code, at least a database, at least a matching filter; at least a table device; at least a warehouse scanner adapted to allow scanning of the products purchased from the catering facility; and at least a digital menu.

### FIELD OF THE Invention

The invention relates to the field of catering, more specifically the present invention provides a technological system for analyzing the needs and tastes of customers by comparing the menus of caterers.

### PRIOR ART

The growing need to have, in the world of catering, a personalized service based on the increase in food needs (nutritional lifestyles, food intolerances and allergies) has led to an ever greater need on the part of catering outlets in Italy and abroad, to adapt their commercial proposal knowing how to include or implement in their service dishes and ingredients that could satisfy the ever increasing requests for customization, sometimes not only of necessity, but also of taste. In recent years, a growing trend has been noted in the development of allergies by the general population, which today represent 4% of the adult population and 5% of the infant population. These data led the EU, with the European regulation 1169 of 2011, to make the exposure of the 14 main allergens present in the general population, both in fresh and packaged products, but also in catering, mandatory.

In fact, every caterer needs to identify not only the ingredients that make up their dishes, but also any contaminating allergenic ingredients present in the preparation.

Not being able, with ease, to identify a correct food offer that is exhaustive of one's needs, has led to a cost in time and to dissatisfaction with the result in the search on the consumer's point of view, and for the caterer not to intercept an adequate audience of people capable of becoming customers of their restaurant. There are several digital services that have been developed in recent years to address this problem.

An example is the subject of the patent application US20130311310A1 of G. ZELL. The invention relates to a restaurant communication system and method that uses digital menus. A restaurant communication system comprising first and second mobile devices located in a restaurant, a server and a plurality of receiving devices. Receiving devices are located in the restaurant in places where special dishes are prepared. The server is located in a remote location with respect to the restaurant and can be connected wirelessly to the first mobile device, the second mobile device and the receiving devices. The server has a database that stores a menu with a plurality of dishes, each dish being associated with an image of the dish, a description of the dish and a location in the restaurant where this dish is prepared. An application of the first mobile device makes the dishes with images and descriptions appear on the display, in addition to sending an order request to the second mobile device and the appropriate receiving devices via the server when the user places an order.

An example is the subject of the patent application US20170109843A1 of J. R. BERG, R. P. TALIANCICH, JR. M. MONGER. The invention relates to a system and method for mobile-assisted digital waiter.

The invention provides a mobile-assisted digital waiter service implemented via a communication network. A mobile device can be configured with a digital waiter application, which, when run from the mobile device, can assist a user/customer in the process of dining at a restaurant or ordering takeaway items. For example, the digital waiter application can allow a user/customer to view menus, place orders and pay the bill from their mobile device. The digital waiter application can enhance the dining experience for the user/customer by providing a personalized digital menu to the user/customer, which includes at least a custom menu item generated based on a customer's previous order history.

Another example is the subject of the patent application U.S. Pat. No. 7,953,873B1 of D. O. MADURZAK. The invention relates to a network service for filtering menus based on user information.

The invention provides a service of identifying menu items to a user of the system and information on acceptable restaurant menu items based on ingredients that the system user prefers or is trying to avoid. The menu item identification service can receive information on ingredients that the system user prefers or wants to avoid and information on a restaurant of interest to the system user. The menu item identification service can use a database to identify restaurant menu items and associated ingredients. The menu item identification service may present the user with menu items offered by the restaurant that have favorite ingredients and/or have no ingredients to avoid or that have limited quantities of the ingredient. Menu items with ingredients to avoid can be displayed along with indicators to avoid. The system user can then use this information to select a menu item and/or restaurant.

The current digital catering services, which aim to bring together the two players in the catering world, do not provide exhaustive information on the food offer (how many dishes suitable for the customer, and which courses), nor the ingredients used to communicate transparency and adequacy of their offer to the needs of the diner. In fact, the inventions described provide systems and methods focused on greater practicality and speed in order management.

The object of the present invention is to propose a matching system for catering which comprises a web portal and/or application capable of connecting users with restaurants having in their menu the food offers suitable for their food needs. Such system also allows caterers to compose the dishes on their menu, being able to choose from thousands of foods categorized and divided by food needs.

Even more advantageously, the system involves portable devices to ensure a lot of freedom and a wide choice of options for individual users.

### DESCRIPTION OF THE INVENTION

According to the present invention, a matching system for catering is implemented which allows the food needs of users to meet the culinary offers of caterers by combining the favorable aspects of software and hardware technology.

The invention provides a web portal and/or application that contains information relating to individual caterers and their culinary offer, in order to allow users to choose the caterer most suited to their tastes and needs. When a user registers on said web portal and/or application, in a specific user section he/she can fill in his/her Food Identity Card, the system then generates an identification code that allows the rapid transmission of the data contained in the Food Identity Card.

The web portal and/or application allows a user and/or a group of users to book a table, have directions to reach the restaurant, have a direct telephone and/or live chat contact with the restaurant chosen in order to make reservations and/or home delivery orders. The web portal and/or application is provided with offline functions to allow users to be able to configure their profile with their preferences, analyze the history of restaurants visited and find contacts and addresses that remain saved on their personal device in predetermined number and times, to allow the caterer to upload the orders registered through said warehouse scanner to his/her own private section. The portal also allows the use of voice commands to offer access to all services even for people with impaired vision.

The system includes two fundamental components which are a matching filter responsible for advanced search algorithms by user and by user group in relation to the respective Food Identity Cards, and a database specifically built to include the mapping of numerous foods, combinations thereof and complete dishes, also indicating data such as nutritional values and the presence of allergens. The Food Identity Card and the digital menus of the restaurants participating in the system are composed by referring to the database provided and the matching filter finally connects users and accommodation facilities suitable for their needs. Said matching filter also lends itself to a standalone implementation in a perspective of partnership with international players such as web search engine managers, in this case it provides an interface for the choice of foods and dishes from said database, allowing the use thereof by users outside the system by means of special APIs. The filter is also able to draw on the entire list of ingredients and nutritional values of a dish present in the database even only through its name, also indicating which diets it is suitable for and which possible allergens it contains. This also allows an implementation of the system with a backward process, that is, such as to start from one or more ingredients and then find all the possible dishes that contain them. The filter thus designed allows the implementation in a wide range of instruments and technologies, including the latest generation, such as for the displays of digital refrigerators. The web portal and/or application lends itself to the implementation of a home menu application that allows users to find various recipes with the data relating to their Food Identity Card and to find any missing ingredients through direct search in the nearest shops.

The web portal and/or application is structured in such a way as to notify catering facilities when a user subject to food intolerances and/or allergies in any form makes a reservation and/or order, the portal therefore advises and reminds the kitchen operators, depending on the type of intolerance and/or allergy, from mild to acute, some effective strategies to meet the particular needs of the user, such as the use of separate utensils, the change of gloves, gown, execution of the preparation away from other dishes containing dangerous ingredients.

The system involves the use of devices installed at the tables of the individual catering facilities. These devices are able to read the identification code and show the user the menu indicating courses, dishes and foods that coincide with the constraints expressed on said Food Identity Card. The devices are also able to detect when an ingredient, marked as dangerous on a user's Food Identity Card, is present in some dishes offered on the restaurant's menu, and to send a specific visual and/or audio signal. The identification code is read through a reception device which can provide for a Bluetooth and/or Wi-Fi network connection, or even the presence of a camera for optical scanning of the code. The table device is connected to the mains and/or is fitted with a battery for correct energy supply, offers the possibility of paying the bill via a special credit card slot, and has a space-saving design and a rest function to avoid the accidental triggering of commands while the table is occupied. The reading of the identification code can also be used for booking and confirmation of the tables at said catering facility.

To speed up and automate the menu digitization process, the catering facility can adopt a warehouse scanner, able to read the barcodes of the products purchased and wirelessly communicate the products and ingredients contained therein to the appropriate caterer section of the web portal and/or application.

The identification code can also be generated for a group of people by putting together the Food Identity Cards of individual users in a specific section of the web portal and/or application dedicated to groups which is also provided with accessory and complementary functions such as instant messaging and invitation systems. In the case of a group booking, the matching filter is adapted to perform a weighted average of the needs of several people, returning decreasing results, from the facilities with greater compliance with the constraints, to those less suitable.

### DESCRIPTION OF THE FIGURES

The invention will hereinafter be described in at least a preferred embodiment thereof by way of non-limiting example with the aid of the accompanying figures, in which:

FIG. 1 shows a general view of the matching system for catering 100;

FIG. 2 shows an axonometric view of said table device 104.

### DETAILED DESCRIPTION OF THE INVENTION

The present invention will now be described purely by way of non-limiting or binding example with the aid of the figures, which illustrate some embodiments relative to the present inventive concept.

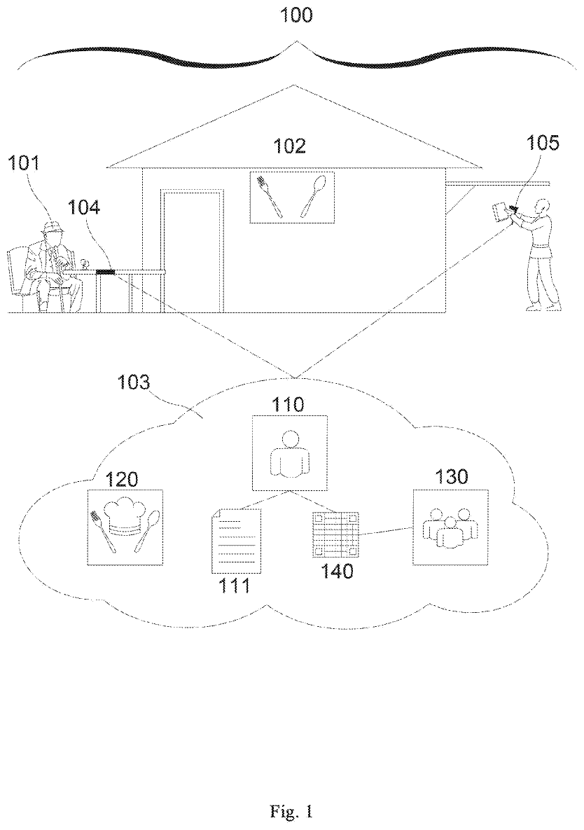

With reference to FIG. 1, a general view of said matching system for catering 100 according to the present invention is shown. In FIG. 1, as in the following description, the embodiment of the present invention considered to be the best to date is illustrated.

Said matching system for catering 100 comprises at least a user 101, at least a catering facility 102, at least a web portal and/or application 103, at least a table device 104, at least a warehouse scanner 105, at least a digital menu 106, at least a user section 110, at least a Food Identity Card 111, at least a home menu application 112, at least a catering owner section 120, at least a group section 130, at least an identification code 140, at least a database 150, at least a matching filter 160.

Said user 101 connects to said web portal and/or application 103 adapted to provide a platform in which to allow said catering facility 102 to easily offer a complete overview of its services.

Said catering facility 102 is provided with said table device 104 on each table to allow said user 101 to make his/her order, also consulting said digital menu 106, in compliance with the limits and preferences set through said web portal and/or application 103. Said catering facility 102 adapted to adopt said warehouse scanner 105 to have a rapid scan of the products purchased and to retrieve, when supplied, the complete list of the ingredients contained. Said user section 110 of said web portal and/or application 103 allows said user 101 to enter their personal data, taste preferences, food intolerances and/or allergies in said Food Identity Card 111. Said user section 110 allows said user 101 to access said home menu application 112 adapted to supply numerous recipes conforming to the data relating to said Food Identity Card 111, and to find any missing ingredients by direct search in the nearest shops. Said catering owner section 120 of said web portal and/or application 103 adapted to allow said catering facility 102 to upload data relating to its products. Said group section 130 of said web portal and/or application 103 adapted to allow a group of people to combine the data of each user section 110 to obtain a combined search of the catering facilities satisfying the constraints imposed by each user of the group. Said group section 130 and said user section 110 adapted to provide said automatically generated identification code 140, adapted to allow said table device 104 to immediately recognize each individual Food Identity Card 111.

Said web portal and/or application 103 adapted to allow the filtering of accommodation facilities through specific algorithms contained in said matching filter 160. All the information added to said Food Identity Card 111, to said digital menu 106 and in general all the information useful for the correct functioning of said matching filter 160, are contained in said database 150 adapted to map foods, their combinations and all data relating to nutritional values and the presence of allergens in food. Said matching filter 160 is able to access information on food, nutritional values, ingredients and the presence of allergens even just using the name of the individual dish and/or food.

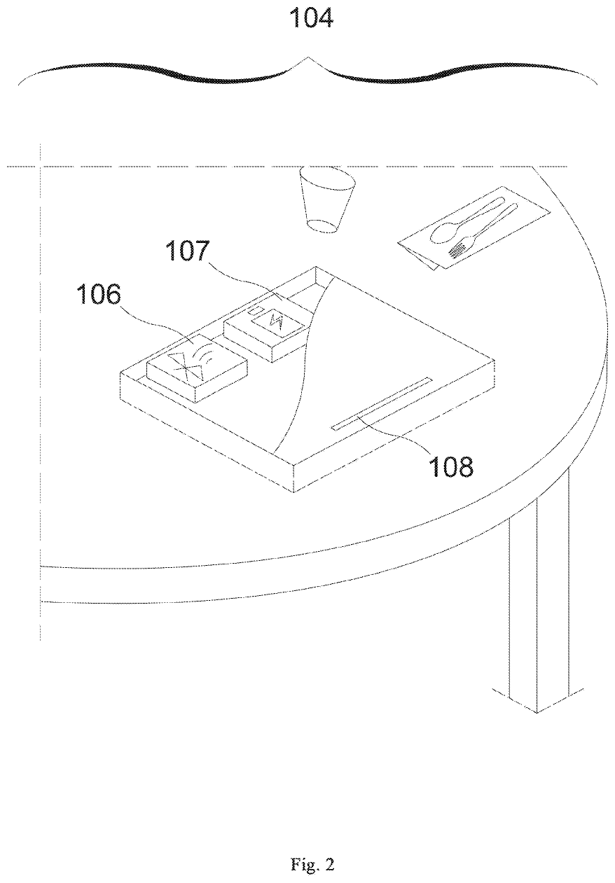

With reference to FIG. 2, an axonometric view of said table device 104 of said matching system for catering 100 is shown. Said table device 104 will be described with reference to FIGS. 1 and 2.

Said table device 104 comprises at least a receiving apparatus 107, at least a battery and/or connection to the electrical network 108, at least a credit card slot 109.

Said table device 104 is adapted to read said identification code 140 through said receiving apparatus 107 so as to present to said user 101 the offer of the menu indicating courses, dishes and foods that coincide with the constraints expressed in said Food Identity Card 111. Said receiving apparatus adapted to allow connectivity via Bluetooth, Wi-Fi network and/or through optical sensors such as cameras, for reading said identification code 140.

Said battery and/or connection to the electrical network 108 supplies energy to said table device. Finally, said slot for credit card 109 allows the possibility of paying the bill directly from the table.

Finally, it is clear that modifications, additions or variants may be made to the invention described thus far which are apparent to those skilled in the art, without departing from the scope of protection that is provided by the appended claims.

1. Matching system for catering, adapted to match the food needs of at least a user with the culinary offers of at least a catering facility that adheres to the system; said system comprising:
at least a web portal and/or application adapted to provide a platform in which to allow said catering facility to easily offer a complete overview of its services to said user;
at least a table device adapted to allow said user to make his/her order in compliance with the limits and preferences set through said web portal and/or application;
at least a warehouse scanner adapted to allow scanning of the products purchased from said catering facility and to retrieve, when supplied, the complete list of the ingredients contained;
at least a digital menu that said catering facility makes available for consultation on said web portal and/or application including all information relating to dishes, ingredients, nutritional values and allergens;
said web portal and/or application comprising:
at least a user section adapted to allow said user to enter his/her personal data, taste preferences and food intolerances in at least a Food Identity Card;
at least a catering owner section adapted to allow said catering facility to upload data regarding its products on said web portal and/or application;
at least a group section adapted to allow a group of people to combine the data of each user section to obtain a combined search of the catering facilities satisfying the constraints imposed by each user of the group;
at least an identification code generated automatically, adapted to allow said table device with an immediate recognition of said user and/or of a group of users and of said Food Identity Card;
at least a database adapted to contain the mapping of foods and their combinations;
at least a matching filter adapted to contain the algorithms such as to allow the filtration of the catering facilities on the basis of said Food Identity Card.

2. The matching system for catering, according to claim 1, wherein said table device comprises at least a receiving apparatus adapted to read said identification code so as to present to said user the menu offering indicating courses, dishes and foods that coincide with the constraints expressed in said Food Identity Card; said receiving apparatus adapted to allow Bluetooth, Wi-Fi network connectivity and/or through optical sensors, for the reception of said identification code; said table device adapted to comprise at least a battery and/or connection to the electrical network to ensure the correct energy supply thereof; said table device (104) adapted to offer the possibility of paying the check through at least a credit card slot; said table device adapted to have a compact design and a stand-by function to avoid the accidental triggering of commands while the table is occupied.

3. The matching system for catering, according to claim 1, wherein said Food Identity Card associated with said user includes all the information relating to food preferences, intolerances and allergies of said user to which an indicator of the intensity of intolerance and/or allergy is associated with a graduated scale to indicate from the mildest to the most acute; said user fills in said Food Identity Card through said user section by adding ingredients, dishes and combinations from said database; said Food Identity Card allows the automatic filtering of catering facilities by interfacing with said matching filter and with said digital menu.

4. The matching system for catering, according to claim 1, wherein said matching filter is adapted to examine the data contained in said Food Identity Card and to compare them with said digital menu of said catering facility for identifying the facilities meeting the needs of said user; said matching filter also suitable for a standalone implementation with a view to partnership with international players such as web search engine managers, in this case, said matching filter provides an interface for the selection of foods and dishes from said database allowing them to be used by users outside the system with special APIs; said matching filter adapted to identify ingredients, nutritional values, allergens present, and diets associated with a single dish using its name for searching in said database; said matching filter adapted to identify all the dishes and/or courses associated with one or more ingredients through said database.

5. The matching system for catering, according to claim 1, wherein said user section allows the implementation of a home menu application adapted to allow said user to find various recipes with the data relating to his/her Food Identity Card and to find any missing ingredients through direct search in the nearest shops.

6. The matching system for catering, according to claim 1, wherein said web portal and/or application also allows the reservation of a table by said user at said catering facility; said web portal and/or application adapted to allow the use of said identification code in order to scan it through said table device, on specially reserved tables, to confirm the reservations made by said user and provide said user with the menu filtered according to his/her preferences.

7. The matching system for catering, according to claim 1, wherein said web portal and/or application is adapted to signal to said catering facility when said user subject to food intolerances and/or allergies in any form makes a reservation and/or order; said web portal and/or application adapted to advise and remind kitchen operators, depending on the type of intolerance and/or allergy, from mild to acute, some effective strategies to meet the particular need of said user.

8. The matching system for catering, according to claim 1, wherein said table device is adapted to detect when an ingredient marked as dangerous on said Food Identity Card of said user is present in some dishes offered on the menu of said restaurant and to send a specific visual and/or audio signal.

9. The matching system for catering, according to claim 1, wherein said warehouse scanner is adapted to read the bar codes of the products purchased by said catering facility and wirelessly communicate the products and ingredients contained therein to the appropriate catering owner section of said web portal and/or application.

10. The matching system for catering, according to claim 1, wherein said web portal and/or application is adapted to generate said identification code univocally in the case of groups of several people in relation to everyone's dietary needs, in order to enclose the information contained in each user section in a more compact form and adapted to speed up the scanning step by said table device; in the case of a group booking, said matching filter is adapted to perform a weighted average of the needs of several people, returning decreasing outcomes, from the facilities with greater compliance with the constraints, to those less suitable.

11. The matching system for catering, according to claim 1, wherein said web portal and/or application allows the search and identification on the map of said catering facility when this is compliant with the constraints imposed by said user, and is adapted to provide road directions for reaching the same; said web portal and/or application adapted to offer direct telephone contact and/or in the form of live chat with said catering facility in order to make reservations and/or home delivery orders.

12. The matching system for catering, according to claim 1, wherein said web portal and/or application comprises offline functions relating to said user section in order to be able to configure one's own profile with one's own preferences; said web portal and/or application provided with offline functions to allow said user to analyze the history of visited catering facilities and find their contacts and addresses that remain saved on his/her personal device in a predetermined number and times; said web portal and/or application provided with offline functions relating to said catering owner section in order to be able to load the orders registered through said warehouse scanner in one's own private section.

13. The matching system for catering, according to claim 1, wherein said web portal and/or application allows the invitation in said group section for said user, and provides group instant messaging systems to allow quick organization between multiple users.

14. The matching system for catering, according to claim 1, wherein said web portal and/or application allows the use of voice commands being also optimized for use by people with impaired vision.

15. The matching system for catering, according to claim 2, wherein said Food Identity Card associated with said user includes all the information relating to food preferences, intolerances and allergies of said user to which an indicator of the intensity of intolerance and/or allergy is associated with a graduated scale to indicate from the mildest to the most acute; said user fills in said Food Identity Card through said user section by adding ingredients, dishes and combinations from said database; said Food Identity Card allows the automatic filtering of catering facilities by interfacing with said matching filter and with said digital menu.

16. The matching system for catering, according to claim 15, wherein said matching filter is adapted to examine the data contained in said Food Identity Card and to compare them with said digital menu of said catering facility for identifying the facilities meeting the needs of said user; said matching filter also suitable for a standalone implementation with a view to partnership with international players such as web search engine managers, in this case, said matching filter provides an interface for the selection of foods and dishes from said database allowing them to be used by users outside the system with special APIs; said matching filter adapted to identify ingredients, nutritional values, allergens present, and diets associated with a single dish using its name for searching in said database; said matching filter adapted to identify all the dishes and/or courses associated with one or more ingredients through said database.

17. The matching system for catering, according to claim 16, wherein said user section allows the implementation of a home menu application adapted to allow said user to find various recipes with the data relating to his/her Food Identity Card and to find any missing ingredients through direct search in the nearest shops.

18. The matching system for catering, according to claim 17, wherein said web portal and/or application also allows the reservation of a table by said user at said catering facility; said web portal and/or application adapted to allow the use of said identification code in order to scan it through said table device, on specially reserved tables, to confirm the reservations made by said user and provide said user with the menu filtered according to his/her preferences.
